(19) United States
(12) Patent Application Publication
(10) Pub. No.: US 2006/0031479 A1
(43) Pub. Date: Feb. 9, 2006

(54) Methods and apparatus for configuration, state preservation and testing of web page-embedded programs

(76) Inventor: Christian Stig Rode, Waltham, MA (US)

Correspondence Address: CHRISTIAN S. RODE;RODE CONSULTING, INC., 2412 STEARNS HILL RD., WALTHAM, MA, 02451, US

(21) Appl. No.: 11/010,086

(22) Filed: Dec. 11, 2004

Related U.S. Application Data
(60) Provisional application No. 60/528,997, filed on Dec. 11, 2003.
(60) Provisional application No. 60/530,238, filed on Dec. 18, 2003.

(51) Int. Cl. G06F 15/173

(52) U.S. Cl. 709/224

(57) ABSTRACT

New and enhanced methods for configuring, preserving state and testing of executable code embedded in a web page, are disclosed.

### CROSS REFERENCE TO RELATED APPLICATIONS

This application claims benefit and priority from

Provisional Application 60/528,997, Filed Dec. 11, 2003

Provisional Application 60/530,238, Filed Dec. 17, 2003

Provisional Application 60/, Filed Apr. 25, 2004

### STATEMENT REGARDING FEDERALLY SPONSORED RESEARCH OR DEVELOPMENT

Not Applicable

### REFERENCE TO A MICROFICHE APPENDIX

None

### BACKGROUND OF THE INVENTION

1. Field of the Invention

This invention relates to the field of embedded applet programs (such as Java, JavaScript, .NET, ActiveX, etc.), HTML/XML/SGML programming and software test methodologies.

2. Description of Prior Art

The author has previously publicly disclosed methods for initializing a Java or JavaScript applet using the URL documentbase (Java) or document.URL/location.href mechanisms (JavaScript) and other, similar mechanisms that exist in nearly all client-side programming environments. Both static and dynamically-created links have been used to pre-configure the applet for a particular use, or in response to a larger functionality to which the URL-configured applet is a subservient module. The advantage of this mechanism is the elimination of intermediary server software, with associated development, maintenance and operating costs.

Systems have been previously disclosed in the prior art for presenting unified input mechanisms for applying (captured) test vectors to a hardware or software device under test (DUT), to simplify maintenance and development by re-using inputs that exist principally to execute the basic function(s) of the device. The prior art does not disclose the use of the URL (URI) mechanism for testing purposes.

Further, the prior art does not disclose mechanisms for capture of applet state data corresponding to user-verified conditions, by means of a URL and web server. Such captured applet state data may be used as raw material for the automated creation of test vectors. Software testing is a tedious and burdensome activity for which automation is desirable to improve quality and efficiency. Usually a piece of software must be manually qualified at least once for correctness, however subsequent modifications may break the functionality and so it is theoretically necessary to repetitively test the same function over and over to ensure that quality is maintained. For the reasons previously mentioned, it is highly desirable to do this re-testing automatically to the extent possible by means of test vectors, and to collect raw test vector material in an intuitive way by presenting a regular user interface which can be approved or not.

As a separate issue, certain types of executable programs (for example, Java applets) are reinitialized whenever a web page is surfed away from and then returned to (within the same browser window), and it is desirable to create a mechanism that preserves the state of the applet so that the user can pick up where s/he left off and not have to reenter all their data. In the default configuration of most browsers, Browser “Cookies”, and HTML/XML form data are preserved when a browser page is returned to, however applets are reinitialized.

The following books/documents provide relevant background and are incorporated by reference:
RFC 1866 (HTML 2.0), IETF (Internet Engineering Task Force):
   http://www.ietf.org/rfc/rfc 1866.txt
RFC 1945 (HTTP 1.0), IETF: http://www.ietf.org/rfc/rfc1945.txt
RFC 2048 (HTTP 1.1), etc., IETF: http://www.ietf.org/rfc/rfc2048.txt
RFC 2396 (URI Generic Syntax), IETF: http://www.ietf.org/rfc/rfc2396.txt
HTML 3.2, W3C (World-Wide Web Consortium):
   http://www.w3.org/TR/REC-html32
RFC 2109 (Cookies), W3C: http://www.w3.org/Protocols/rfc2109/rfc2109.txt
Provisional Application 60/528,997, Filed Dec. 12, 2003
Provisional Application 60/530,238, Filed Dec. 17, 2003
Provisional Application 60/, Filed Apr. 4, 2004

As used in this document, the following words with capitalized first letters have special meanings:
A Computer includes any number and organization (cluster, array, etc.) of CPUs, memory/storage/communication devices, etc. and whose function includes the processing of data.
A Client is a Computer that is capable of accepting input from and providing output to an operator. A Client may also be a Server.
A Server is a Computer that provides computational, data storage, communication or other services for at least one (and usually more than one) Client. A Server may also be a Client.
A User is an individual or process that uses a Client. One Client can have multiple Users.
A Network includes all proxy servers, gateways, routers, communication channels, cabling, etc. that comprise a communication medium between two Computers, such as a private, local network or a public network such as the internet.
A Browser is a Client program that at least a) accepts data in the form of a display list (e.g. HTML, XML) and b) wherein at least one of the interpretable display list elements is a “hyperlink” having the capability to “link” to display list data on Servers other than (and in addition to) that which provide the list containing the link. c) uses an intrinsically stateless, file-oriented protocol (e.g. HTTP) to retrieve objects named in the display list (e.g. GIF, JPG). Typical Browsers have many other capabilities in addition to these. The words “link” and “hyperlink” are standard terms of art within the field of HTML, HTTP and the WWW.
Form Structure Data is, in the preferred embodiment, those elements of a fetched Browser display list (e.g. HTML <FORM> tag and associated elements) that create corresponding user data entry (form) elements in which data can be entered and submitted to a Server (such submitted data is Form Data). Form Structure Data can also be transmitted in the form of instructions, such as Java virtual machine bytecodes (alternative embodiment), ActiveX controls, JavaScript source, etc., in which case said instructions will be subsequently executed to programmatically create form elements substantially similar to those presented by means of an HTML form.
An Applet is a small program running within a Browser web page. Example Applet technologies include Java, ActiveX, .NET, etc.
Cookies are distinct, named pieces of storage space on the client accessible to an Applet, either directly (e.g., JNLP PersistanceService “Muffins” and FileOpen/SaveService), or indirectly (e.g., via JavaScript and LiveConnect). They may also be referred to more generically as Persistent Browser-Associated State.
Where URL is used, the equivalence of URI, URN, or the like is implied

### BRIEF SUMMARY OF THE INVENTION

NOTE: Although the present discussion is grounded in the preferred embodiment of JavaScript testing of a Java applet, equivalent systems would include JavaScript testing of .NET or ActiveX components, and JavaScript testing of other JavaScript functionality. Also possible is Java testing of Java/.NET/ActiveX/JavaScript via the “LiveConnect” mechanism. In short, the test methods can reside in any mechanism that can communicate directly, or via inter-applet communication or via the LiveConnect mechanism and the claims should not be construed as specific to the preferred embodiment. The key functions are the ability to store and fetch field data from a URL and compare any fetched data to reference data, which is also stored in the URL.

NOTE 2: With regards to state preservation, this is chiefly a problem of Java applets, although any HTML/XML applet environment that suffers from re-initialization will benefit from the present invention. It requires either direct access or access via an intermediary (such as LiveConnect) to the underlying HTML/XML Document Object Model (DOM) or to “Cookies” (Persistent Browser-Associated State), so that applet data can be temporarily saved in an HTML/XML form field or Cookie, for later retrieval when the page is revisited.

NOTE 3: Within the remainder of this document, “Applet” (note capitalization) should be construed to mean any HTML—embeddable and executable content, including, but not restricted to Java, JavaScript, ActiveX, .NET web forms, JavaScript, VBScript, etc. “HTML” or “XML” should be construed to include any SGML-based UI language. A “Cookie” is a type of semi-permanent client-side browser data storage defined by Netscape Communications, as used here, it refers to any available client-side storage other than an HTML form element.

An existing URL-configuration mechanism was modeled on the standard HTTP GET mechanism. A web page is called in this manner http://<hostname>/<path>/applet_page.html?arg1=value1&arg2=value2... That is to say, arg-value pairs are conjoined by “=” assignment and collected together by means of an “&” separator, just as with the HTTP GET mechanism. Fields with the same names as the arguments are set with the defined value data.

Obviously, other encodings are possible, in fact the URL may typically contain up to 2048 bytes of arbitrary byte data, with unprintable or disallowed characters escaped by means of the standard %XX hex-code mechanism. That is to say, arbitrary binary data may be included within the URL. However, for clarity, the preferred embodiment stores and retrieves text-formatted data, even for numeric values. However, nothing in this disclosure should be construed to assume restriction to only text data, including use of the word “string” which in the present application implies a concatenation of byte data.

Within the targeted applet (DUT), there must be fields to receive the values listed in the URL. In the preferred embodiment, the fields are named the same as the arguments, however it's also possible to have a table of fields and then simply have the URL say “...?f1=value1&f2=value2...” where the table maps the fn to the actual field names or even “value1&value2&value3” where the positional order within the URL implies which value is to be set. Again, for clarity, we have used an HTTP GET-like “?arg1=value1&arg2=value2” example.

For testing purposes, this URL mechanism is extended by means of check parameters that do not necessarily name an output field in the applet, but have a defined naming or positional relationship to output fields. For example, a check on field “output1” might be named “check_output1”. Note that this syntax distinction is made in part to allow for the possibility of fields that are bidirectional. Within the URL, this might be look like “...&inputN=ivalueN&check_output1=ovalue1&...”. When the args are parsed, either by the program itself in self-test, or by a controlling program (as in the preferred embodiment), the value for “output1” is fetched from the DUT and compared to known-good data. If any mismatch occurs, a message is logged or brought to the user's attention.

The creation of (URL-based) test information (“test vectors”) may be manual, or, it may be partially automated by means of collecting input-output datasets under the control of a review person or agent. Said reviewer or agent enters data and examines the output data to determine whether the dataset is good or bad, then initiates an action to save the dataset with an annotation as to whether it is good or bad. In the preferred embodiment, collection consists of an entry being logged in a HTTP log file with a “vector_state” parameter of “good” or “bad” as appropriate. Alternatively, this information may be saved in a separate database, such as a flat text file.

For state-preservation purposes, data from the applet is collected together in the HTTP GET format and then this data is stored in an HTML/XML form field. This HTML/XL form field has its original value set to “”, so the presence of something other than a null or empty string indicates data to be later preloaded into the applet in a manner similar to, but in preference to, any URL data that may be present. That is, the same mechanism of concatenated string data is used for both configuration and state preservation. In the preferred embodiment, the example is a Java applet that concatenates its internal data into an HTTP GET query string and then makes a LiveConnect JavaScript call to store this data in a field (“document.forms.initedf.save_params”) for later retrieval. In the preferred embodiment, this data is automatically loaded by the applet, although it's equally plausible to load the data on command of another programmatic environment, especially as consequence of the JavaScript onLoad function.

### DETAILED DESCRIPTION OF THE PREFERRED EMBODIMENTS

See attached code listings.

All methods in the preferred embodiment center around the creation and parsing of a standard HTTP GET-style URL string, which in conventional use appends form data in a “QUERY_STRING” to a form-processing action URL: http://<base_URL>/<action>?<QUERY_STRING>. Here, the same mechanism is used to pass arguments to a client-side web page for configuration of an embedded applet. This applet and/or web page itself possesses methods to create a similar configuration string which is then stored in an HTML/XML form or in a Cookie (see above). Applet state is typically not preserved when a page is surfed away from and then returned to, however the typical default browser configuration does preserve HTML/XML form contents under the same circumstances, so the ability to create a configuration string, save it, restore it and reconfigure the Applet with this information amounts to a state preservation mechanism where none exists naturally.

This configuration mechanism has been further extended with pseudo-field parameters that are recognized as special cases and processed after the applet has configured itself. These parameters are checked against the actual state found within the applet after other parameters are applied so as to validate its function.

To facilitate the collection of known good test vectors, a mechanism is disclosed to present the user with a interface second to that of the applet which allows that user to vote thumbs up or down on whether s/he likes what the applet is doing. A vote either way causes the user interface associated logic (JavaScript, Java, .NET, etc.) to retrieve the applet state together with any applied inputs and forward it to a web server by fetching a URL with the applet state appended in typical HTTP GET format. Alternatively the UI could merely trigger this same functionality contained entirely within the applet. The web server can passively log this activity to its server logs or can initiate a process, such as a CGI-script to store the data to a database.

There are some optimizations in the present embodiment that should be noted:

First, the manner in which saved data is reloaded is slightly different from how it is loaded from a URL: In the former, fields are loaded without triggering their individual action/changed events. The values are loaded in the left-right order they are presented in either the document URL or saved data. Because the applet knows the order in which the values were saved and are coming, it knows that the last value to be loaded for each section will be “C5” and so triggers an event only when it sees that value. This speeds loading by eliminating re-calculation that could overwrite already loaded fields and is any event pointless.

An example-specific issue is that the field names R1, R2, R3 are reused for multiple similar data sets. These sets are selected by topoN=xxxx argument-value pairs. So the data is massaged to change the names from R1_1 (meaning R1 for stage1) to simply R1, preceded by a topo statement to switch the calculator to a mode where any R1 data is sent to the R1 appropriate for the stage.

What is claimed is:

1. A method for testing functionality of an Applet embedded within a Web Page, said method comprising the steps of
a. retrieving configuration and testing data from a URL (URI),
b. storing said configuration data into said Web Page-embedded Applet,
c. triggering a calculation based on said configuration data,
d. retrieving calculation results from said triggered calculation and for associating and comparing said testing data to said calculation results.

2. A method for preserving state of an Applet embedded within a Web Page, said method comprising the steps of:
a. collecting Applet state into at least one text string,
b. saving said at least one text string into at least one Form element embedded within a Web Page, where said at least one Form element has been previously marked as invalid,
c. selecting Applet configuration data from either said at least one Form element or from a URL(URI), where said at least one Form element is selected when said element is marked valid,
d. configuring said Applet by means of said Applet configuration data.

3. A method for preserving state of an Applet embedded within a Web Page, said method comprising the steps of:
a. collecting Applet state into at least one text string,
b. saving said at least one text string into at least one Cookie, where said at least one Cookie has been previously marked as invalid,
c. selecting Applet configuration data from either said at least one Cookie or from a URL(URI), where said at least one Cookie is selected when said element is marked valid,
d. configuring said Applet by means of said Applet configuration data.

4. A method for testing Applet functionality and preserving Applet state, said method comprising the steps of methods 1 and 2, where said Applet and URL (URI) are the identical Applet and URL respectively.

5. A method for testing Applet functionality and preserving Applet state, said method comprising the steps of methods 1 and 3, where said Applet and URL (URI) are the identical Applet and URL respectively.

6. A method for collecting test vector data from an Applet and a User, said method comprising the steps of:
a. presenting a user interface associated with said Applet, said user interface containing at least one user interface element to allow the user to signify whether the Applet state is good or bad.
b. acting on User signification of good or bad Applet state by collecting Applet state into at least one text string and appending it to a server URL.
c. initiating an access to said server URL, such that the server records the Applet state data.

7. The method of claim 6, where the server records the Applet state data in a web server log file.

8. The method of claim 6, where the server initiates a process that records the Applet state data in a database.

9. A method for testing Applet functionality and saving Applet state data, comprising the methods of claim 1 and claim 6, wherein said Applet is the identical Applet, but the testing URL and the collected test vector URL are distinct.
